(19) United States
(12) Patent Application Publication
(10) Pub. No.: US 2016/0352971 A1
(43) Pub. Date: Dec. 1, 2016

(54) ELECTRONIC DEVICE AND IMAGE PROCESSING METHOD

(71) Applicant: KYOCERA CORPORATION, Kyoto (JP)

(72) Inventor: Miho KANEMATSU, Osaka (JP)

(21) Appl. No.: 15/163,488

(22) Filed: May 24, 2016

(30) Foreign Application Priority Data
May 25, 2015 (JP) 2015-105470

(51) Int. Cl. H04N 1/60; G06T 7/40

(52) U.S. Cl. CPC H04N 1/60; G06T 7/408; H04N 2201/0089

(57) ABSTRACT

An electronic device according to the present disclosure includes a display and at least one processor. The display shows a background image and a display object arranged on the background image, the background image including a plurality of colors. The at least one processor controls the display. When a first color that occupies the largest area in a first region including at least part of the background image and a second color that occupies the largest area in the display object included in the first region are similar, the at least one processor uses a third color different from the first color and the second color to enhance the display object.

### CROSS-REFERENCE TO RELATED APPLICATION

The present application claims priority under 35 U.S.C. §119 to Japanese Patent Application No. 2015-105470, filed on May 25, 2015, entitled “Electronic Device and Image Processing Method.” The content of which is incorporated by reference herein in its entirety.

### FIELD

The present disclosure relates to an electronic device and an image processing method.

### BACKGROUND

An electronic device is known which can improve visibility of a display object shown on a screen. For example, a mobile phone terminal is known which can efficiently set a coloration of the color of a display object (e.g., character) shown on a screen and its background color to a coloration having a good sense of color and causing less discomfort.

### SUMMARY

An electronic device according to an aspect includes a display and at least one processor. The display is configured to show a background image and a display object arranged on the background image, the background image including a plurality of colors. The at least one processor is configured for controlling the display to identify a first color that occupies the largest area in a first region including at least part of the background image, identify a second color that occupies the largest area in the display object included in the first region, determine whether or not the first color and the second color are similar, and when the first color and the second color are similar, use a third color different from the first color and the second color to enhance the display object.

A “dominant color” as used herein means a color being used for a background image and occupying the largest area in a certain region on the background image or a color being used for a display object and occupying the largest area in that display object.

An image processing method according to an aspect is an image processing method for controlling a display of an electronic device by at least one processor included in the electronic device. The display is configured to show a background image and a display object arranged on the background image, the background image including a plurality of colors. The at least one processor is configured to control the display. The image processing method includes identifying a first color that occupies the largest area in a region including at least part of the background image, identifying a second color that occupies the largest area in the display object included in the region, determining whether or not the first color and the second color are similar, and when the first color and the second color are similar, using a third color different from the first color and the second color to enhance the display object.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a front view of a smartphone which is an electronic device according to a first embodiment.

FIG. 2 shows a background image shown on a display of FIG. 1.

FIG. 3 shows display objects shown on the display of FIG. 1.

FIG. 4 is a functional block diagram for describing the functions of the smartphone of FIG. 1.

FIG. 5 is a functional block diagram for describing the functions regarding image processing performed by a control unit of FIG. 4.

FIG. 6 is a flowchart for describing the flow of enhancement processing for a display object performed by the control unit of FIG. 4.

FIG. 7 shows the background image of FIG. 1 having been divided into a plurality of regions.

FIG. 8 is a flowchart for describing the flow of enhancement processing for a character string performed by the control unit of FIG. 4.

FIG. 9 schematically shows the relation between the distance in an RGB color space between two colors and a threshold value used when determining similarity of the two colors.

FIG. 10 is a flowchart for describing the flow of enhancement processing for an image object which is a display object performed by the control unit of FIG. 4.

FIG. 11 shows the display after the enhancement processing for display objects performed by the control unit of FIG. 4.

FIG. 12 is a flowchart for describing the flow of enhancement processing for a character string performed by a control unit of a smartphone according to a variation of the first embodiment.

FIG. 13 shows a display after the enhancement processing for display objects performed by the control unit of the smartphone according to the variation of the first embodiment.

FIG. 14 is a flowchart for describing enhancement processing for a character string performed by a control unit of a smartphone according to a second embodiment.

FIG. 15 is a flowchart for describing enhancement processing for an image object performed by the control unit of the smartphone according to the second embodiment.

FIG. 16A shows the distance in a color space between a dominant color of a region of interest and a dominant color of a display object included in the region of interest before the enhancement processing.

FIG. 16B shows the distance between the dominant color of the region of interest and a dominant color of the display object included in the region of interest after the enhancement processing.

FIG. 17 shows a background image shown on a display of a smartphone according to a third embodiment and display objects arranged on the background image.

FIG. 18 shows a background image shown on the display of the smartphone according to the third embodiment.

FIG. 19 is a flowchart for describing the flow of enhancement processing for a display object performed by a control unit of the smartphone according to the third embodiment.

FIG. 20 is a flowchart for describing the flow of enhancement processing for a character string performed by the control unit of the smartphone according to the third embodiment.

FIG. 21 is a flowchart for describing the flow of enhancement processing for an image object which is a display object performed by the control unit of the smartphone according to the third embodiment.

FIG. 22 shows the display after the enhancement processing for display objects performed by the control unit according to the third embodiment.

### DETAILED DESCRIPTION

Hereinafter, embodiments of the present disclosure will be described in detail with reference to the drawings. In the drawings, the same or corresponding portions have the same reference characters allotted, and detailed description thereof will not be repeated.

### First Embodiment

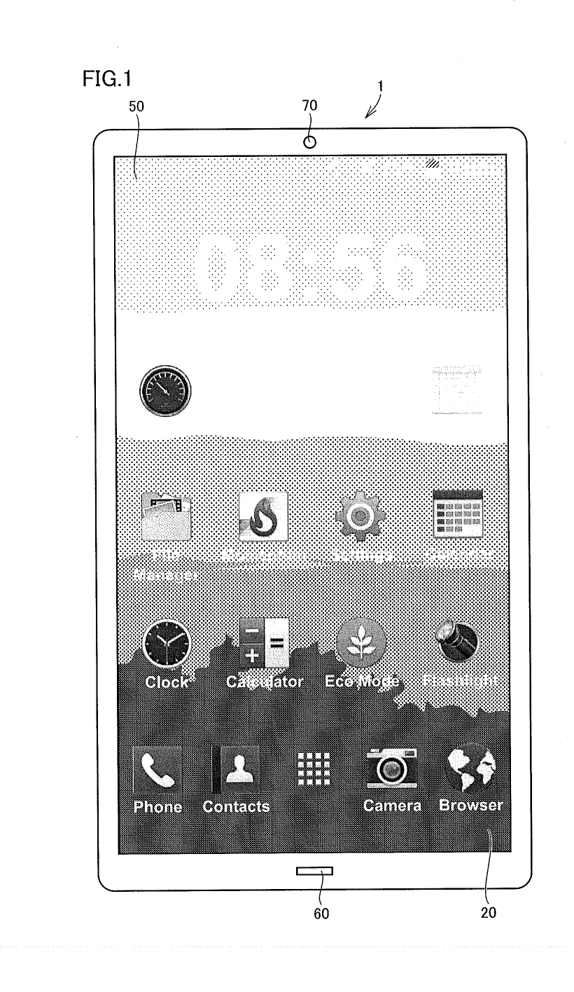

FIG. 1 is a front view of a smartphone 1 which is an electronic device according to a first embodiment. Referring to FIG. 1, smartphone 1 includes a speaker 70 at a longitudinally upper position of a main body, a microphone 60 at a longitudinally lower position of the main body, as well as a display 20 and an input unit 50 at a central position. Display 20 shows icons, pictograms and character strings on the background image. A screen shown on display 20 is a home screen shown first when a user starts operating smartphone 1. A user can freely set the background image of the home screen.

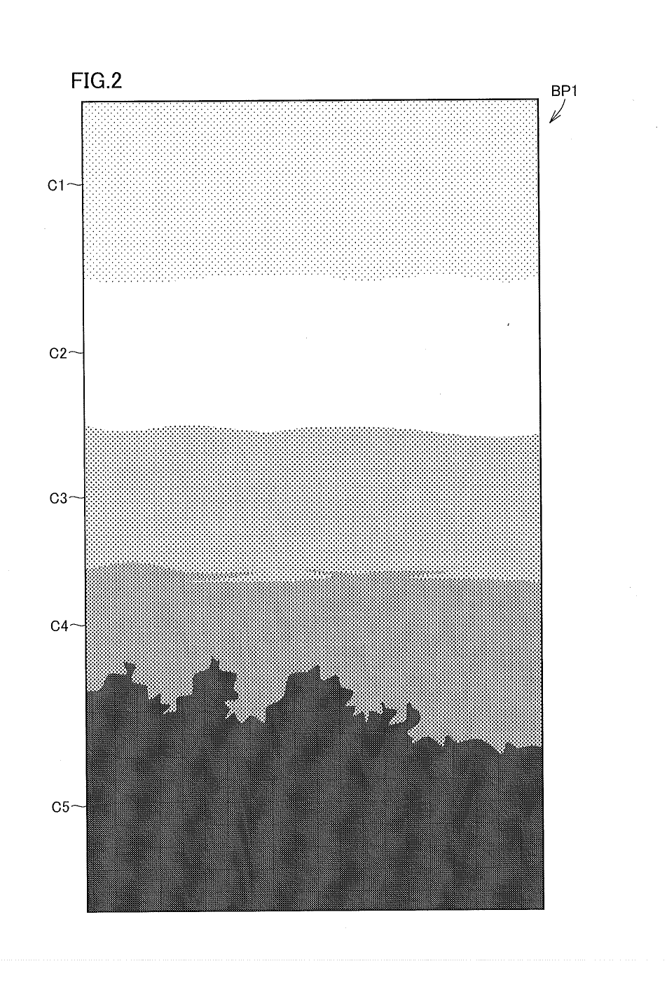

FIG. 2 shows a background image BP1 shown on display 20 of FIG. 1. Referring to FIG. 2, background image BP1 includes five colors C1 to C5. These colors decrease in brightness in the order of C2, C1, C3, C4, and C5 from a lighter color to a darker color.

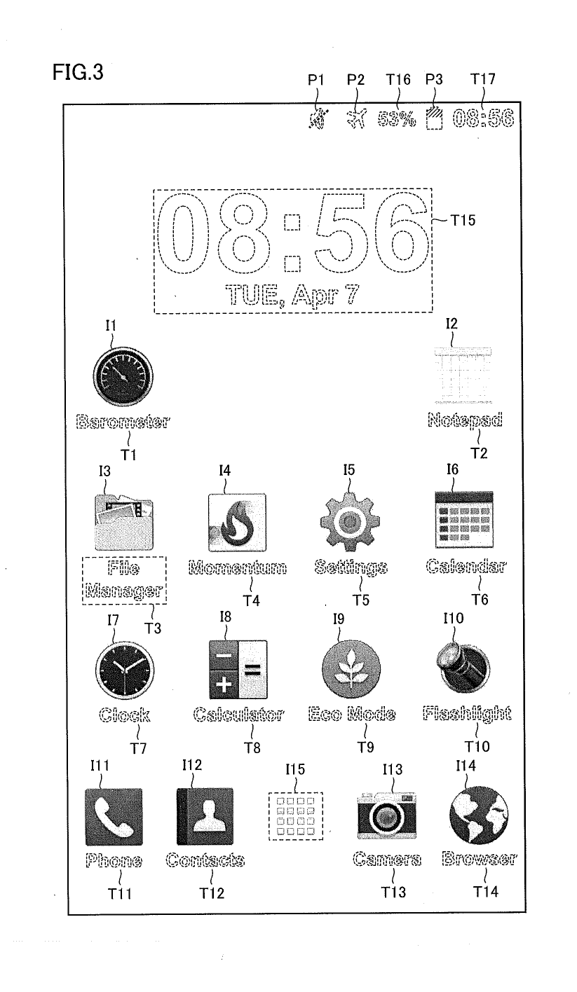

FIG. 3 shows display objects shown on display 20 of FIG. 1. Display 20 includes pictograms P1 to P3, character strings T1 to T17 and icons I1 to I15. Although the outline of some character strings and images is shown by dotted lines in FIG. 3, the dotted lines are shown for indicating the presence of such character strings and images, and are not actually shown on display 20.

Referring to FIGS. 1 to 3, some of the pictograms, character strings and icons shown on display 20 are not readily visible. For example, each of pictograms P1 to P3 and character strings T16, T17 has color C2, and is hardly visible since color C2 has a small difference in brightness from color C1 of the background. Character string T15 has color C2 having a small or no difference in brightness from colors C1, C2 which are the colors of the background. Thus, part of character string T15 that indicates the time on the background having color C1 is not clearly visible with the outline blurred, and part of character string T15 that indicates the date and day of the week on the background having color C2 is not visible at all.

Some of the pictograms, character strings and icons shown on display 20 are clearly visible even though they have color C2 identical to pictograms P1 to P3 and character string T15 to T17. For example, each of character strings T11 to T14 has a character color of color C2, but is clearly visible since the character color has a great difference in brightness from color C5 of the background.

When a background image includes a plurality of colors, the background image differs in color for each region in which a display object is shown. Thus, even display objects of the same color tone (e.g., character strings of the same color) differ from each other in less visibility depending on the regions in which they are shown. The method of improving visibility differs among regions in which the respective display objects are shown, and it is not possible to define a method uniformly applicable to the entire screen.

In the first embodiment, the visibility of a display object can be improved by dividing the background image into a plurality of regions and changing, for each region, the dominant color of a character string and the color of a surrounding region of an image object are changed to a complementary color of the dominant color of each region.

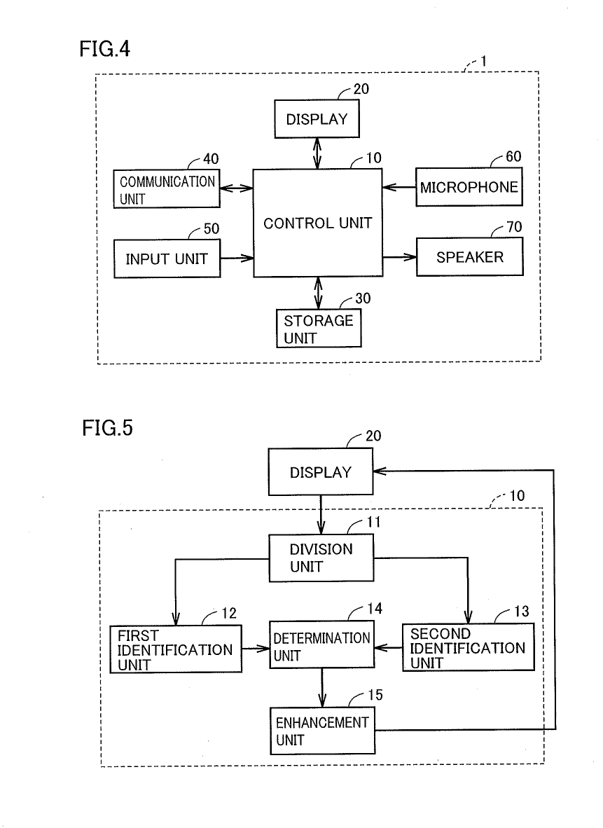

FIG. 4 is a functional block diagram for describing the functions of smartphone 1 of FIG. 1, Referring to FIG. 4, smartphone 1 includes a control unit 10, display 20, a storage unit 30, a communication unit 40, input unit 50, microphone 60, and speaker 70.

Although not shown, control unit 10 can include a processor, such as a CPU (Central Processing Unit), and an SRAM (Static Random Access Memory) or a DRAM (Dynamic Random Access Memory) as a storage element, and can execute integrated control of smartphone 1, For example, control unit 10 can perform image processing for an image shown on display 20, and can output information on the image after the processing to display 20.

Display 20 can perform displaying based on a signal received from control unit 10. Display 20 may be implemented by, for example, a liquid crystal display, a plasma display, or an organic electroluminescence display.

Storage unit 30 can store an OS (Operating System) read by control unit 10 for execution, programs of various applications (e,g., a program for performing image processing), and various types of data used by the programs (e.g., an image file that can be used as a background image). Storage unit 30 may include, for example, a ROM (Read Only Memory) which is a non-volatile semiconductor memory, an EEPROM (Electrically Erasable Programmable ROM), a flash memory, or a HDD (Hard Disk Drive) which is a storage device.

Communication unit 40 includes an antenna switch, a duplexer, a power amplifier, a low noise amplifier, and a band pass filter, neither shown. Communication unit 40 can make communications over a communication network of a telecommunications carrier in accordance with the LTE (Long Term Evolution) or CDMA (Code Division Multiple Access) technology. Communication unit 40 can process a signal received by the antenna, and can send the signal to control unit 10. Control unit 10 can send a signal to communication unit 40, and can send the signal subjected to signal processing in communication unit 40. Communication unit 40 includes a wireless LAN circuit and a wireless LAN antenna neither shown, and based on WiFi (registered trademark), can communicate with a WiFi-enabled apparatus such as, for example, a WiFi access point.

Input unit 50 can receive an input from a user, and can send a signal based on the input to control unit 10. Input unit 50 may be implemented by buttons or a touch panel, for example.

FIG. 5 is a functional block diagram for describing the functions regarding image processing performed by control unit 10 of FIG. 4. Referring to FIG. 5, control unit 10 includes a division unit 11, a first identification unit 12, a second identification unit 13, a determination unit 14, and an enhancement unit 15. Division unit 11, first identification unit 12, second identification unit 13, determination unit 14, and enhancement unit 15 are each implemented by the control unit executing the program for performing image processing.

Although control unit 10 shown in FIG. 5 includes division unit 11, first identification unit 12, second identification unit 13, determination unit 14, and enhancement unit 15, control unit 10 may perform operations instead of division unit 11, first identification unit 12, second identification unit 13, determination unit 14, and enhancement unit 15.

Control unit 10 may be at least one processor. In accordance with various embodiments, the at least one processor may be implemented as a single integrated circuit (IC) or as multiple communicatively coupled IC's and/or discrete circuits. It is appreciated that the at least one processor can be implemented in accordance with various known technologies. In one embodiment, the processor includes one or more circuits or units configurable to perform one or more data computing procedures or processes. For example, the processor may include one or more processors, controllers, microprocessors, microcontrollers, application specific integrated circuits (ASICs), digital signal processors, programmable logic devices, field programmable gate arrays, or any combination of these devices or structures, or other known devices and structures, to perform the functions described herein.

Division unit 11 divides a background image shown on display 20 into a plurality of regions based on the resolution of display 20, the smallest area necessary for showing each display object, the coordinates of each display object, and the like, and outputs information on the divided background image to the first identification unit and the second identification unit.

First identification unit 12 can identify a dominant color DC1 of each region of the divided background image obtained from division unit 11. In the first embodiment, first identification unit 12 can calculate the most frequently used RGB value by counting the RGB value of each pixel included in each region, identify the color expressed by the calculated RGB value as dominant color DC1 of each region, and output dominant color DC1 to determination unit 14. An RGB value indicates a combination (R, G, B) of values specifying the respective colors of red (R), green (G) and blue (B) by values of 0 to 255. For example, white is expressed as (255, 255, 255), black is expressed as (0, 0, 0), and gray is expressed as (128, 128, 128).

Second identification unit 13 can identify a dominant color DC2 of each display object included in each region. Similarly to first identification unit 12, second identification unit 13 can also identify dominant color DC2 of a display object by counting the RGB value of each pixel, for example, and can output dominant color DC2 to determination unit 14.

Determination unit 14 can determine whether or not dominant color DC1 identified by first identification unit 12 and dominant color DC2 identified by second identification unit 13 are similar. In the first embodiment, determination unit 14 regards the RGB value of each of dominant colors DC1 and DC2 as the coordinates in the RGB color space, and when the distance in the RGB color space between dominant colors DC1 and DC2 is less than a predetermined threshold value, determines that dominant colors DC1 and DC2 are similar, and outputs the determination result for each region and information on the divided background image to the enhancement unit.

Enhancement unit 15 performs enhancement processing for a display object shown in each region of the background image based on the determination result received from determination unit 14. In the first embodiment, when dominant color DC1 of a background image and dominant color DC2 of a display object are similar, a complementary color of dominant color DC1 is used to enhance the display object. The complementary color of dominant color DC1 is a color that is positioned exactly opposite to dominant color DC 1 on a color circle. The specific method of enhancing a display object will be described later.

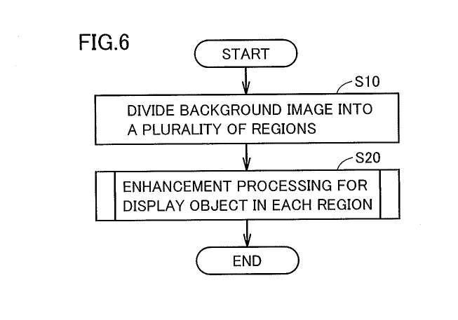

The enhancement processing for a display object performed by control unit 10 of smartphone 1 according to the first embodiment will be described below with reference to FIGS. 6 to 9.

FIG. 6 is a flowchart for describing the flow of enhancement processing for a display object performed by control unit 10 of FIG. 4. Referring to FIG. 6, in step S10, control unit 10 divides background image BP1 into a plurality of regions based on the resolution of background image BP1, the smallest area necessary for showing each display object arranged on background image BP1, the coordinates of each display object, and the like, and advances the process to step S20. In step S20, control unit 10 performs the enhancement processing for a display object.

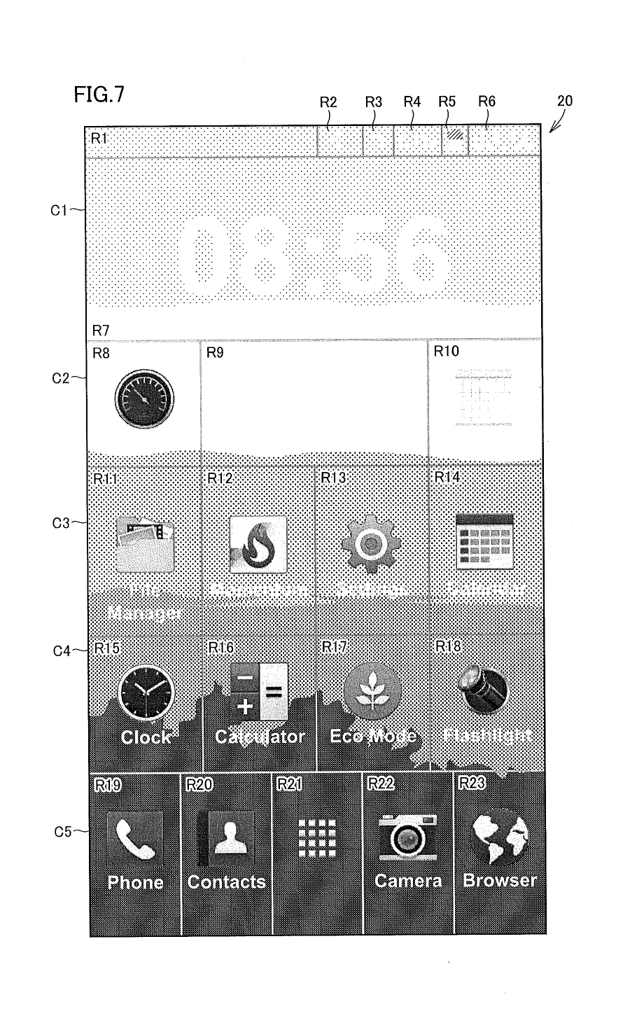

FIG. 7 shows background image BP1 having been divided into a plurality of regions. Referring to FIG. 7, background image BP1 has been divided into regions R1 to R23. Split lines are merely shown for description purposes, and are not shown on an actual screen. Referring to FIG. 3 as well, regions R2, R3 and R5 include pictograms P1 to P3, respectively. Regions R4 and R6 include character strings T16 and T17, respectively. Region R7 includes character string T15. Region R8 includes icon I1 and character string T1. Region R10 includes icon I2 and character string T2. Region R11 includes icon I3 and character string T3. Region R12 includes icon I4 and character string T4. Region R13 includes icon I5 and character string T5. Region R14 includes icon I6 and character string T6. Region R15 includes icon I7 and character string T7. Region R16 includes icon I8 and character string T8. Region R17 includes icon I9 and character string T9. Region R18 includes icon I10 and character string T10. Region R19 includes icon I11 and character string T11. Region R20 includes icon I12 and character string T12, Region R21 includes icon I15. Region R22 includes icon I13 and character string T13. Region R23 includes icon I14 and character string T14. Regions R1 and R9 do not include any display object.

Referring again to FIG. 6, in step S20, control unit 10 performs the enhancement processing for a display object included in each of regions R1 to R23. FIG. 8 is a flowchart for describing the flow of enhancement processing for a character string performed by control unit 10 of FIG. 4. In step S201, control unit 10 calculates the most frequently used RGB value by counting the RGB value of each pixel in a region to be subjected to the enhancement processing (hereinafter also referred to as a “region of interest”) to identify the color corresponding to the calculated RGB value as dominant color DC1, and advances the process to step S202. In step S202, control unit 10 calculates the most frequently used RGB value by counting the RGB value of each pixel of the character string included in the region of interest to identify the color corresponding to the calculated RGB value as dominant color DC2, and advances the process to step S203. In step S203, control unit 10 determines whether or not dominant colors DC1 and DC2 are similar.

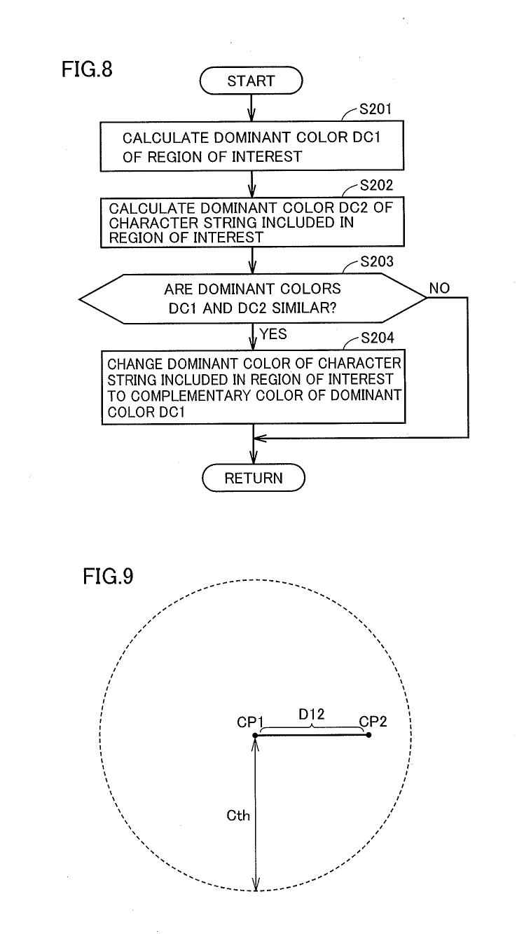

As already described, in determining whether or not two colors are similar, the RGB value of each color is assumed as expressing the coordinates in the color space, and when the distance between the two colors in the color space is less than a predetermined threshold value Cth, it is determined that the two colors are similar. FIG. 9 schematically shows the relation between the distance in the RGB color space between the two colors and threshold value Cth. Referring to FIG. 9, a point in the RGB space corresponding to dominant color DC1 is denoted as a point CP1, and a point in the RGB space corresponding to dominant color DC2 is denoted as a point CP2. The distance between point CP1 and point CP2 is denoted as a distance D12. For example, assuming the RGB value of dominant color DC1 as (R1, G1, B1) and the RGB value of dominant color DC2 as (R2, G2, B2), point CP1 is expressed as (R1, G1, B1), point CP2 is expressed as (R2, G2, B2), and distance D12 is obtained by the following expression (1).

Distance D12={(R1−R2)²+(G1−G2)²+(B1−B2)²}^{1/2} (1)

When point CP2 is located within a sphere S centering on point CP1 and having a radius equal to threshold value Cth, distance D12 is smaller than threshold value Cth. When CP2 is located on the spherical surface or the outside of sphere S, distance D12 is more than or equal to threshold value Cth. It is determined that dominant colors DC1 and DC2 are similar when point CP2 is located within sphere S in the RGB color space, and it is determined that dominant colors DC1 and DC2 are dissimilar when point CP2 is located on the spherical surface or the outside of sphere S.

Referring again to FIG. 8, when dominant colors DC1 and DC2 are dissimilar (NO in S203), control unit 10 terminates the enhancement processing for the character string in the region of interest. When dominant colors DC1 and DC2 are similar (YES in S203), control unit 10 advances the process to step S204. In step S204, control unit 10 changes the dominant color of the character string included in the region of interest to the complementary color of dominant color DC1.

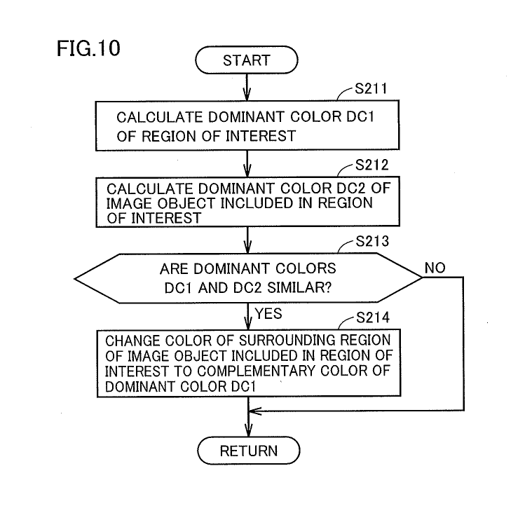

FIG. 10 is a flowchart for describing the flow of enhancement processing for an image object (e.g., icon or pictogram) which is a display object performed by control unit 10 of FIG. 4.

Referring to FIG. 10, in step S211, control unit 10 calculates the most frequently used RGB value by counting the RGB value of each pixel in a region of interest to identify the color corresponding to the calculated RGB value as dominant color DC1, and advances the process to step S212. In step S212, control unit 10 calculates the most frequently used RGB value by counting the RGB value of each pixel of an image object included in the region of interest to identify the color corresponding to the calculated RGB value as dominant color DC2, and advances the process to step S213. In step S213, control unit 10 determines whether or not dominant colors DC1 and DC2 are similar.

When dominant colors DC1 and DC2 are dissimilar (NO in S213), control unit 10 terminates the enhancement processing for the image object in the region of interest. When dominant colors DC1 and DC2 are similar (YES in S213), control unit 10 advances the process to step S214. In step S214, control unit 10 changes the color of a surrounding region of the image object included in the region of interest to the complementary color of dominant color DC1. In the first embodiment, the surrounding region shall be one of rectangles or squares including the image object that has the smallest area and has been enlarged under a predetermined magnification. The surrounding region may be a circle or a polygon other than a quadrangle, and may have any shape as long as it includes a display object within a region of interest and has an area smaller than that of the region of interest.

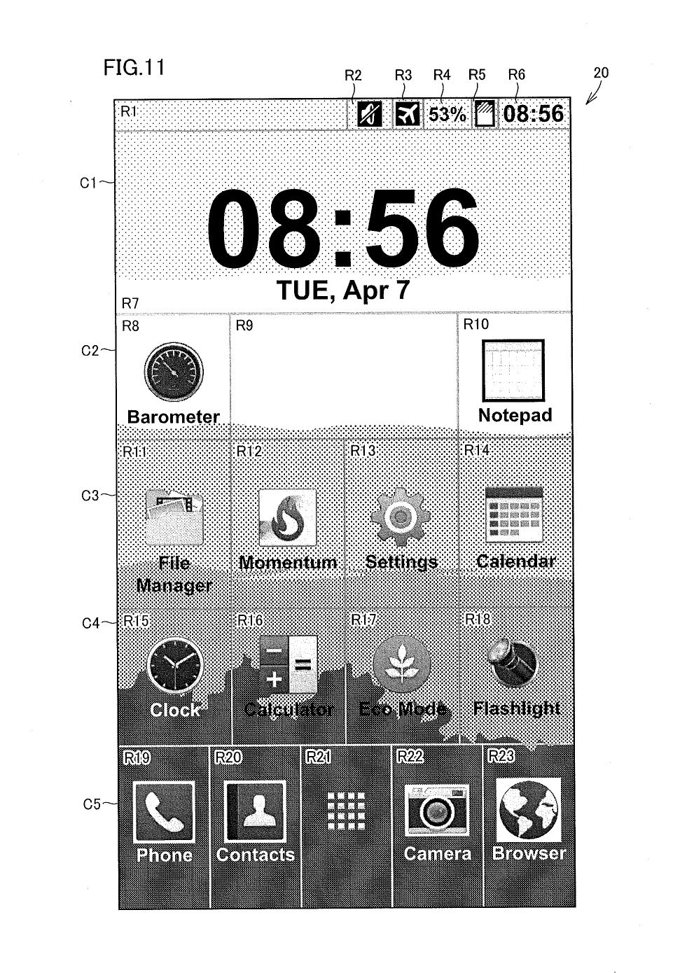

FIG. 11 shows display 20 after the enhancement processing for display objects performed by control unit 10 of FIG. 4. Referring to FIGS. 3, 7 and 11, compared to FIG. 7 before the enhancement processing, it is recognized that the visibility of many display objects has been improved in FIG. 11. For example, although pictogram P1, P2, character string T16, pictogram P3, and character string T17 shown in regions R2 to R6, respectively, are hardly visible in FIG. 7, all the pictograms and character strings are clearly visible in FIG. 11. In regions R2, R3 and R5, the color of the surrounding regions of pictograms P1, P2 and P3 has been changed to the complementary color of color C1. In region R4 and R6, the color of character strings T16 and T17 has been changed to the complementary color of color C1. As to icon I2 and character string T2 shown in region R10 in FIG. 7, the outline of icon I2 is blurred as its dominant color is similar to color C2, and character string T2 is not visible at all as its character color is color C2. In FIG. 11, icon I2 and character string T2 are both clearly visible. In region R10, the color of the surrounding region of icon I2 has been changed to the complementary color of color C2, and the character color of character string T2 has been changed to the complementary color of color C2.

As described above, according to smartphone 1, the visibility of a display object can be improved by changing the dominant color of text shown on the background image including a plurality of colors to the complementary color of the dominant color of a region of interest, and changing the color of a surrounding region of an image object to the complementary color of the dominant color of the region of interest.

### Variation of First Embodiment

In the first embodiment, the visibility of a character string is improved by changing the dominant color of the character string to the complementary color of the dominant color of a region where the character string is included. The method of improving the visibility of a character string is not limited to changing the dominant color of the character string. In a variation of the first embodiment, a case of improving the visibility of a character string by changing the color of a surrounding region of the character string similarly to an image object will be described.

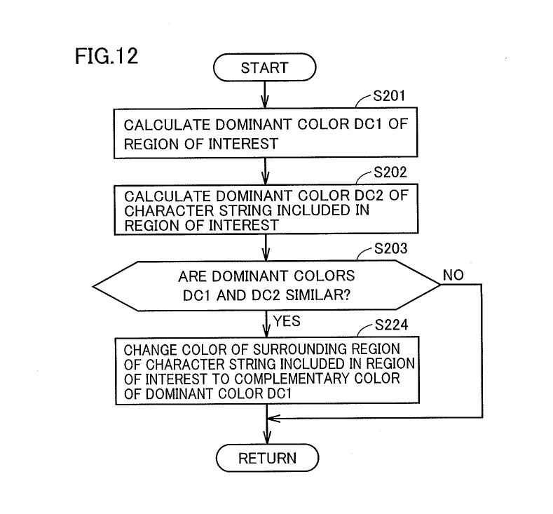

FIG. 12 is a flowchart for describing the flow of enhancement processing for a character string performed by control unit 10 of a smartphone according to a variation of the first embodiment. The variation of the first embodiment differs from the first embodiment only by step S224 of FIG. 12, and the remaining configuration is similar to that of the first embodiment. In the variation of the first embodiment, step S204 of FIG. 8 is replaced by step S224 of FIG. 12. A similar configuration will not be described repeatedly. Referring to FIG. 12, in step 5224, control unit 10 changes the color of a surrounding region of a character string included in a region of interest to the complementary color of dominant color DC1.

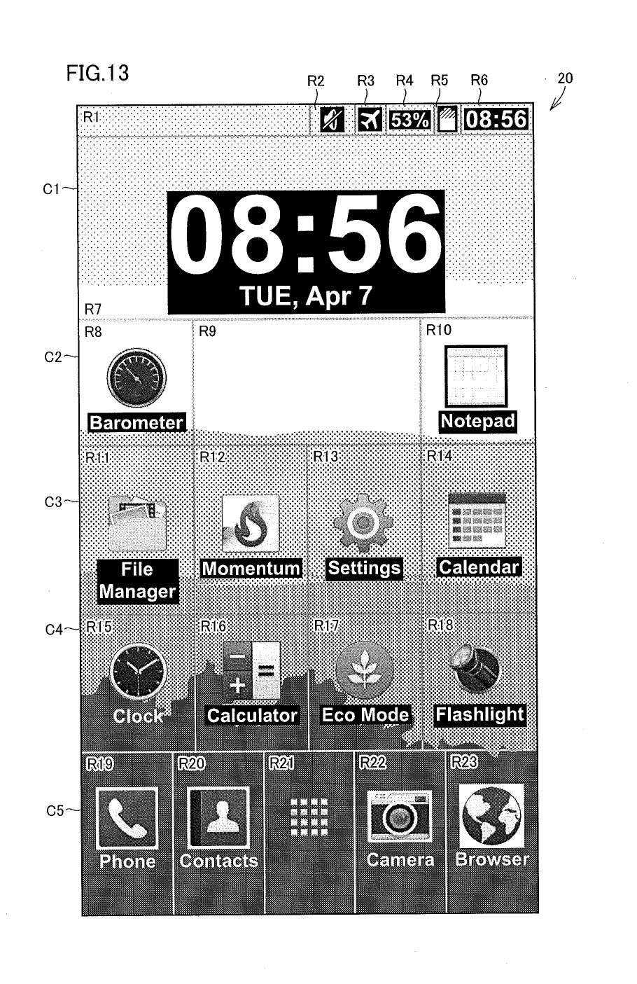

FIG. 13 shows display 20 after the enhancement processing for display objects performed by control unit 10 of the smartphone according to the variation of the first embodiment. Referring to FIGS. 3, 7, 11, and 13, compared to FIG. 7 before the enhancement processing, it is recognized that the visibility of many display objects has also been improved in FIG. 13. As compared with FIG. 11, the icons or pictograms after the enhancement processing are similar to those of the first embodiment, however, the character strings after the enhancement processing differ from those of the first embodiment. For example, the character color of character strings T16 and T17 has been changed in FIG. 11, however, the color of the surrounding regions has been changed in FIG. 13. The same applies to other character strings.

As described above, according to the smartphone of the variation of the first embodiment, the visibility of a display object shown on a background image including a plurality of colors can be improved by changing the color of the surrounding region of the display object to the complementary color of the dominant color of a region of interest.

### Second Embodiment

In the first embodiment and the variation of the first embodiment, the enhancement processing for a display object included in a region of interest is performed using the complementary color of dominant color DC1 of the region of interest. The color used for the enhancement processing is not limited to the complementary color of dominant color DC1 of a region of interest. As a second embodiment, a case where the color used for the enhancement processing may be a color other than the complementary color of dominant color DC1 will be described.

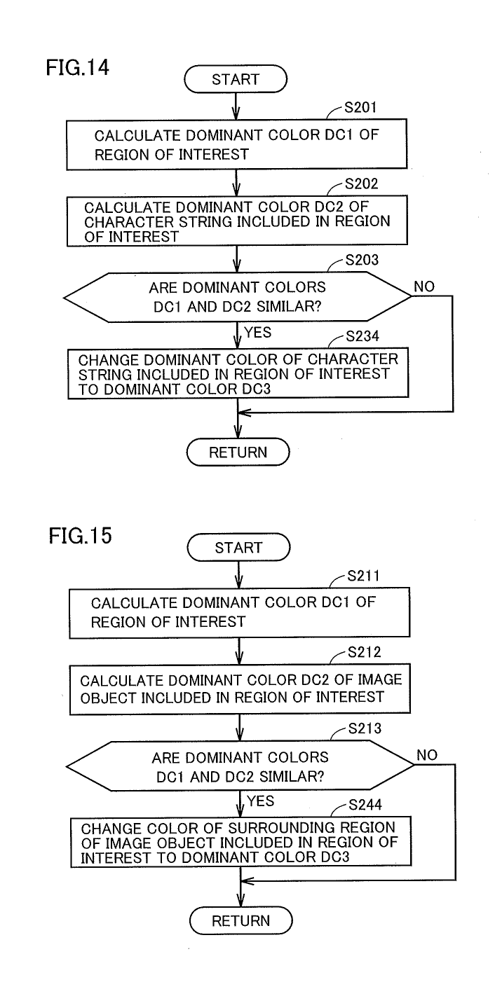

FIG. 14 is a flowchart for describing enhancement processing for a character string performed by control unit 10 of a smartphone according to the second embodiment. FIG. 15 is a flowchart for describing enhancement processing for an image object performed by control unit 10 of the smartphone according to the second embodiment. The second embodiment differs from the first embodiment and the variation of the first embodiment only by step S234 of FIG. 14 and step S244 of FIG. 15, and the remaining configuration is similar to the first embodiment and the variation of the first embodiment. In the second embodiment, step S204 of FIG. 8 (step S224 of FIG. 12) is replaced by step S234 of FIG. 14, and step S214 of FIG. 10 is replaced by step S244 of FIG. 15. A similar configuration will not be described repeatedly.

Referring to FIG. 14, in step S234, control unit 10 changes the dominant color of a character string in a region of interest to a dominant color DC3. In step S234, the color of the surrounding region of the character string may be changed to dominant color DC3. Referring to FIG. 15, in step S244, the color of the surrounding region of an image object included in the region of interest is changed to dominant color DC3.

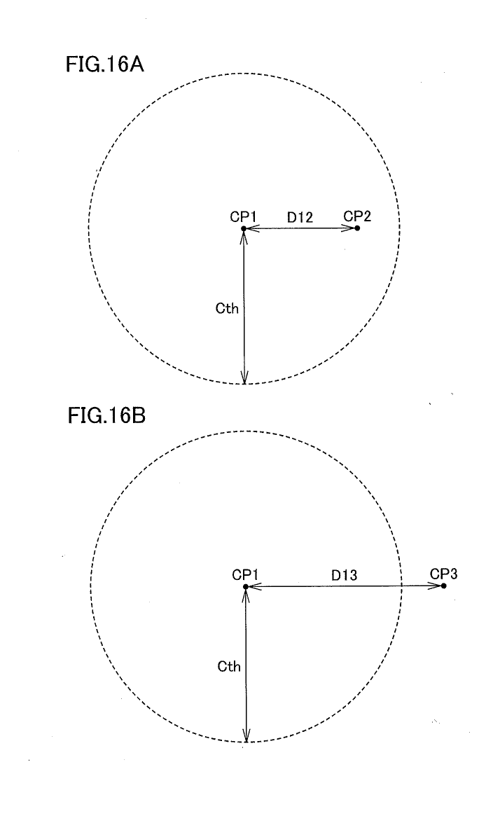

FIG. 16A shows the distance in the color space between dominant color DC1 of the region of interest and dominant color DC2 before the enhancement processing for a display object included in the region of interest. FIG. 16B shows the distance between dominant color DC1 of the region of interest and dominant color DC3 after the enhancement processing for the display object included in the region of interest. Referring to FIG. 16A, when dominant colors DC1 and DC2 are similar, distance D12 in the color space between point CP1 corresponding to dominant color DC1 and point CP2 corresponding to dominant color DC2 is smaller than threshold value Cth. Referring to FIG. 16B, in this case, control unit 10 changes the dominant color of the display object from dominant color DC2 to dominant color DC3 such that the distance from point CP1 in the color space becomes larger than threshold value Cth. A distance D13 in the color space between a point CP3 corresponding to dominant color DC3 and point CP1 is larger than threshold value Cth. Such dominant color DC3 may be determined based on a preset color correspondence table, or the RGB value of dominant color DC3 may be calculated from the RGB value of dominant color DC1 using a predetermined relational expression.

As described above, according to smartphone 1 of the second embodiment, the visibility of a display object shown on a background image including a plurality of colors can be improved by setting the dominant color of a character string or the color of the surrounding region of the character string as well as the color of the surrounding region of an image object so as to increase the difference in brightness between the dominant color of a region of interest and the dominant color of the display object included in the region of interest.

### Third Embodiment

In the first embodiment, the variation of the first embodiment and the second embodiment, the background image is divided into a plurality of regions. As a third embodiment, a case where the visibility of a display object is improved without dividing a background image into a plurality of regions will be described.

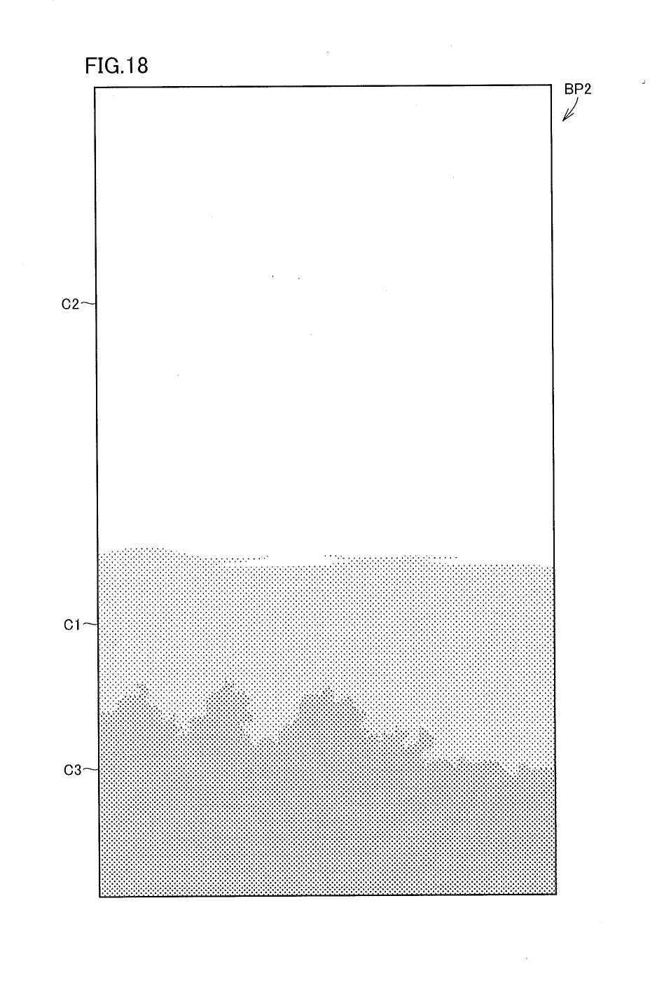

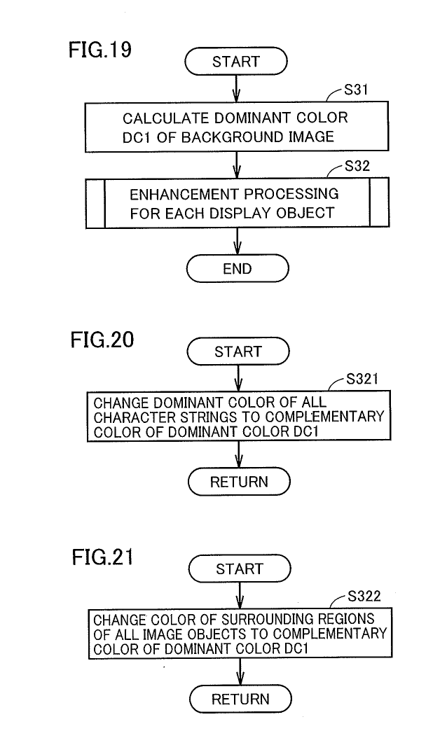

The third embodiment differs from the first embodiment, the variation of the first embodiment and the second embodiment only in that the dominant color of a background image is identified prior to the enhancement processing for a display object rather than dividing the background image into plurality of regions, and the dominant color is used for the enhancement processing for a display object, and in that a background image BP2 shown in FIG. 18 is used as the background image. The remaining configuration is similar. In the third embodiment, FIG. 6 is replaced by FIG. 19, FIG. 8 (FIGS. 12 and 14) and FIG. 10 (FIG. 15) are replaced by FIGS. 20 and 21, respectively, and FIG. 2 is replaced by FIG. 18. A similar configuration will not be described repeatedly.

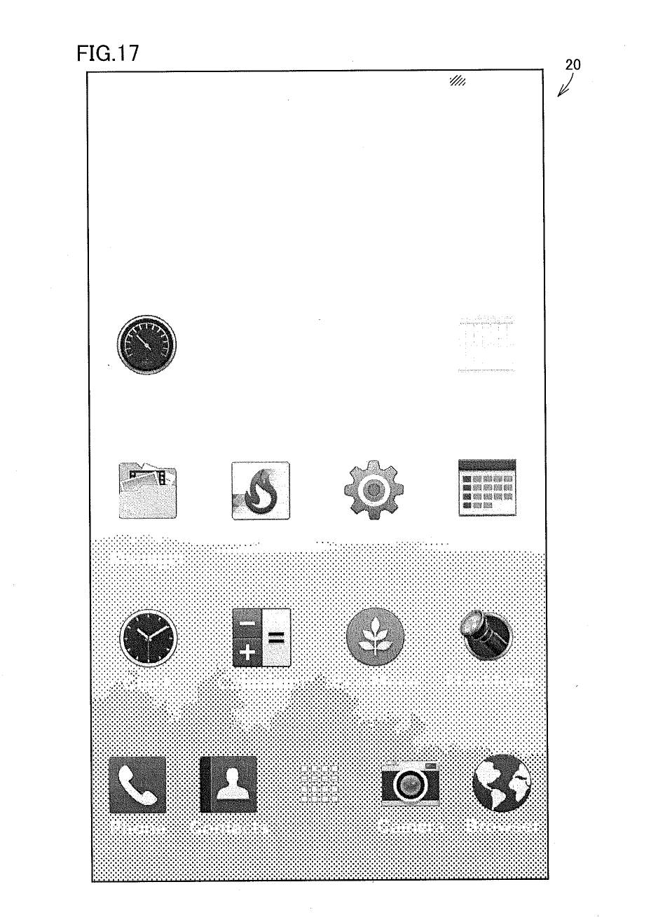

FIG. 17 shows a background image shown on display 20 and display objects arranged on the background image. While the display objects are similar to those of FIG. 3, background image BP2 shown in FIG. 18 is used as the background image. Referring to FIG. 17, background image BP2 includes three colors C1 to C3. These colors decrease in brightness in the order of C2, C1 and C3 from a lighter color to a darker color.

FIG. 19 is a flowchart for describing the flow of enhancement processing for a display object performed by control unit 10 of the smartphone according to the third embodiment. Referring to FIG. 19, in step S31, control unit 10 calculates the most frequently used RGB value by counting the RGB value of each pixel included in background image BP2, identifies the color expressed by the calculated RGB value as dominant color DC1 of background image BP2, and advances the process to step S32. In the third embodiment, dominant color DC 1 of background image BP2 is color C2. In step S32, control unit 10 performs the enhancement processing for each display object.

FIG. 20 is a flowchart for describing the flow of enhancement processing for a character string performed by control unit 10 of the smartphone according to the third embodiment. In step S321, control unit 10 changes the dominant color of all the character strings to the complementary color of dominant color DC1 (color C2). Although the dominant color of a character string is changed to the complementary color of dominant color DC1 in the third embodiment, the color of the surrounding region of the character string may be changed to the complementary color of dominant color DC1.

FIG. 21 is a flowchart for describing the flow of enhancement processing for an image object (e.g., icon or pictogram) which is a display object performed by control unit 10 of the smartphone according to the third embodiment. Control unit 10 changes the colors of the surrounding regions of all image objects to the complementary color of dominant color DC1.

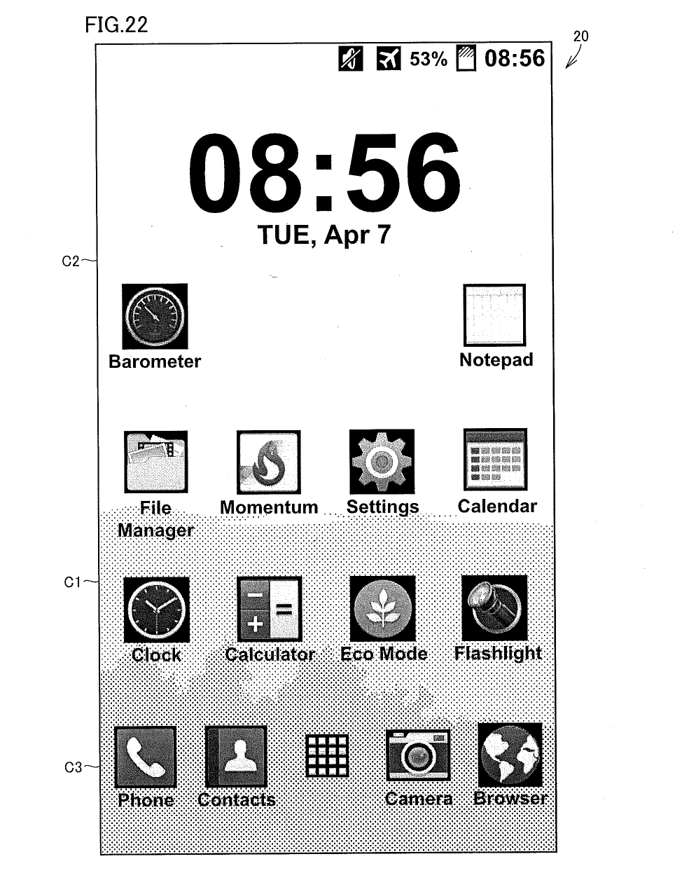

FIG. 22 shows display 20 after the enhancement processing for display objects performed by control unit 10 according to the third embodiment. Referring to FIGS. 3, 17 and 22, compared to FIG. 17 before the enhancement processing, it is recognized that the visibility of many display objects has been improved in FIG. 22. For example, although pictogram P1, P2, character string T16, pictogram P3, and character string T17 are hardly visible in FIG. 17, all the pictograms and character strings are clearly visible in FIG. 22. The color of the surrounding regions of pictograms P1, P2 and P3 has been changed to the complementary color of color C2. The color of character strings T16 and T17 has been changed to the complementary color of color C2. As to icon I2 and character string T2, in FIG. 17, the outline of icon I2 is blurred as its dominant color is similar to color C2, and character string T2 is not visible at all as its character color is color C2. In FIG. 22, icon I2 and character string T2 are both clearly visible. The color of the surrounding region of icon I2 has been changed to the complementary color of color C2, and the character color of character string T2 has been changed to the complementary color of color C2.

As described above, according to smartphone 1 of the third embodiment, the visibility of a display object can be improved by changing the dominant color of a character string shown on a background image including a plurality of colors or the color of the surrounding region of the character string as well as the color of the surrounding region of an image object to the complementary color of the dominant color of the background image.

In the third embodiment, since the dominant color of a character string (or the dominant color of the surrounding region of the character string) becomes the same as the dominant color of the surrounding region of an image object, the consistent visibility can be provided.

The enhancement processing for a display object according to the first to third embodiments is performed when the screen of the display is changed to cause display objects to be shown on the background image, for example. Examples of such a case can include a case where a user starts up a smartphone, a case where a user cancels a screen lock, a case where the appearance of pictograms is changed due to a change in the status of connection with a communication network of a telecommunications carrier or the status of connection with a WiFi-enabled apparatus, and a case where a user taps, flicks or swipes the touch panel to change the screen of the display. Examples of such a case can include a case where a user changes the background image, a case where a user changes the settings so that new pictograms are shown, and a case where a user installs a new application so that a new icon or pictogram is added.

Although the present disclosure has been described and illustrated in detail, it is clearly understood that the same is by way of illustration and example only and is not to be taken by way of limitation, the scope of the present disclosure being interpreted by the terms of the appended claims.

1. An electronic device comprising:
a display configured to show a background image and a display object arranged on the background image, the background image including a plurality of colors; and
at least one processor configured for controlling the display to
identify a first color that occupies the largest area in a first region including at least part of the background image,
identify a second color that occupies the largest area in the display object included in the first region,
determine whether or not the first color and the second color are similar, and
when the first color and the second color are similar, use a third color different from the first color and the second color to enhance the display object.

2. The electronic device according to claim 1, wherein
the at least one processor is configured to
identify the first color by calculating a first RGB value of the first color, identify the second color by calculating a second RGB value of the second color, and
determine that the first color and the second color are similar when a distance in an RGB color space between a first point corresponding to the first RGB value and a second point corresponding to the second RGB value is smaller than a predetermined threshold value, and
a distance in the RGB color space between the first point and a third point corresponding to an RGB value of the third color is larger than the predetermined threshold value.

3. The electronic device according to claim 1, wherein the third color includes a complementary color of the first color.

4. The electronic device according to claim 1, wherein when the first color and the second color are similar, the at least one processor is configured to change the second color to the third color to enhance the display object.

5. The electronic device according to claim 1, wherein when the first color and the second color are similar, the at least one processor is configured to change a color that occupies the largest area, among colors used for the background image, to the third color in a second region to enhance the display object, the second region having a smaller area than the first region and including the display object included in the first region.

6. The electronic device according to claim 5, wherein when the first color and the second color are similar, the at least one processor is configured to change all colors used for the background image to the third color in the second region to enhance the display object.

7. The electronic device according to claim 1, wherein
the at least one processor is configured to divide the background image into a plurality of regions, and
the first region is one of the plurality of regions.

8. The electronic device according to claim 1, wherein the first region includes the background image entirely.

9. The electronic device according to claim 1, wherein the electronic device includes a mobile terminal.

10. An image processing method for controlling a display of an electronic device by at least one processor included in the electronic device, the display being configured to show a background image and a display object arranged on the background image, the background image including a plurality of colors, the at least one processor being configured to control the display, the image processing method comprising:
identifying a first color that occupies the largest area in a region including at least part of the background image;
identifying a second color that occupies the largest area in the display object included in the region;
determining whether or not the first color and the second color are similar; and
when the first color and the second color are similar, using a third color different from the first color and the second color to enhance the display object.
